(19) United States
(12) Patent Application Publication
(10) Pub. No.: US 2009/0119100 A1
(43) Pub. Date: May 7, 2009

(54) ASSOCIATING ANNOTATION RECORDING WITH A CELL PHONE NUMBER

(76) Inventors: Raji L Akella, Austin, TX (US); Gaurav Jain, Santa Clara, CA (US); Michael Lee Masterson, Cedar Park, TX (US); James M. McArdle, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/936,109

(22) Filed: Nov. 7, 2007

(51) Int. Cl. G10L 15/26; H04Q 7/22

(52) U.S. Cl. 704/235; 455/412.1; 704/E15.043

(57) ABSTRACT

A method, system and computer program product for creating voice annotations during a mobile phone call. During the phone call a user engages a trigger on the communication device prompting the phone to first mute the device of the user, and then record an audible message. The audible message, or voice annotation, is automatically linked to the current call information. The voice annotation may be transcribed and stored as a textual annotation. The voice or textual annotation may be retrieved utilizing a graphical user interface (GUI).

### BACKGROUND

1. Technical Field

The present invention generally relates to computer systems and in particular to annotations in mobile computer systems.

2. Description of the Related Art

Throughout the past decade mobile communication devices have evolved tremendously. Manufacturers work diligently to improve mobile communication devices by increasing the functionality of the devices and decreasing the complexities in utilizing the devices. Mobile telephones, for example, have evolved into sophisticated mobile computer systems in which a client may send and receive e-mails, browse the internet, as well as identify one's current global position.

The ability to merge the use of a mobile telephone with the abilities of a personal digital assistant (PDA) has revolutionized daily life. Mobile telephones have transitioned from the capability of only dispatching and receiving phone calls to now provide the ability to perform audio recording, process memos, create documents, send and receive e-mails, and much more. However, there exist a need for enhanced capabilities that merge the technologies of dispatching calls, receiving calls, audio recording, and processing memos in an effective manner.

### SUMMARY OF ILLUSTRATIVE EMBODIMENTS

Disclosed are a method, system and computer program product for creating voice annotations during a mobile phone call. During the phone call a user engages a trigger on the communication device prompting the phone to first mute the device of the user, and then record an audible message. The audible message, or voice annotation, is automatically linked to the current call information. The voice annotation may be transcribed and stored as a textual annotation. The voice or textual annotation may be retrieved utilizing a graphical user interface (GUI).

In one embodiment, a mobile phone is utilized during a conversation to record a voice annotation regarding the current phone call. A trigger is engaged which initiates a software application on the mobile communication device. The software application automatically mutes the phone conversation while the trigger is engaged, then records an audible message. The audible message is automatically linked to the current call information. The voice annotation may be retrieved utilizing audio output component of the phone while the call information (phone number or calling party identification) is displayed on a graphical user interface.

In one embodiment, the client of a mobile communication device receives an incoming call. Prior to retrieving the incoming call, a graphical user interface (GUI) reminds the client of a previously recorded call annotation associated with the calling number. The client may decide to review the call annotation prior to answering the call. Reviewing the call annotation may prompt an automated answering message, alerting the caller to “Please hold, while you are connected”.

In one embodiment, a client may transcribe a previously recorded voice annotation. During review of the voice annotation, a client may choose to transcribe the audible annotation to a textual annotation. A graphical user interface is displayed that allows the client to transcribe the annotation. Following transcription, the client may edit, save, and/or delete the textual annotation utilizing the graphical user interface.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of an example communication device, within which features of the invention may be advantageously implemented;

FIG. 2 is a diagram of communication exchanged between mobile communication devices in accordance with one embodiment of the invention;

FIG. 3 illustrates a graphical user interface to transcribe the voice annotations according to one embodiment of the invention;

FIG. 4 illustrates a graphical user interface for displaying icons representing audible or textual annotations along with call information in accordance with one embodiment of the invention;

FIG. 5 illustrates a graphical user interface for transcribing, editing, saving, and/or deleting call annotations in accordance with one embodiment of the invention;

FIG. 6A illustrates a graphical user interface for displaying call annotations information during an incoming call according to one embodiment of the invention;

FIG. 6B illustrates a graphical user interface by which call annotations are reviewed during an incoming call according to one embodiment of the invention;

FIG. 6C illustrates a graphical user interface enabling an automated answering message to play during an incoming call in accordance with one embodiment of the invention;

FIG. 7A illustrates a graphical user interface allowing call annotations to be displayed prior to an outgoing call according to one embodiment of the invention;

FIG. 7B illustrates a graphical user interface enabling call annotations to be reviewed prior to an outgoing call according to one embodiment of the invention;

FIG. 8 is a logic flow chart illustrating the method of implementing the voice annotation application according to one embodiment of the invention;

FIG. 9 is a logic flow chart illustrating the process for transcribing, editing, saving, and/or deleting call annotations in accordance with one embodiment of the invention; and

FIG. 100 is a logic flow chart illustrating the process of implementing the annotation application during incoming and outgoing calls according to one embodiment of the invention.

### DETAILED DESCRIPTION OF AN ILLUSTRATIVE EMBODIMENT

The illustrative embodiments provide a method, system and computer program product for creating voice annotations during a mobile phone call. During the phone call a user engages a trigger on the communication device prompting the phone to first mute the device of the user, and then record an audible message. The audible message, or voice annotation, is automatically linked to the current call information. The voice annotation may be transcribed and stored as a textual annotation. The voice or textual annotation may be retrieved utilizing a graphical user interface (GUI).

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

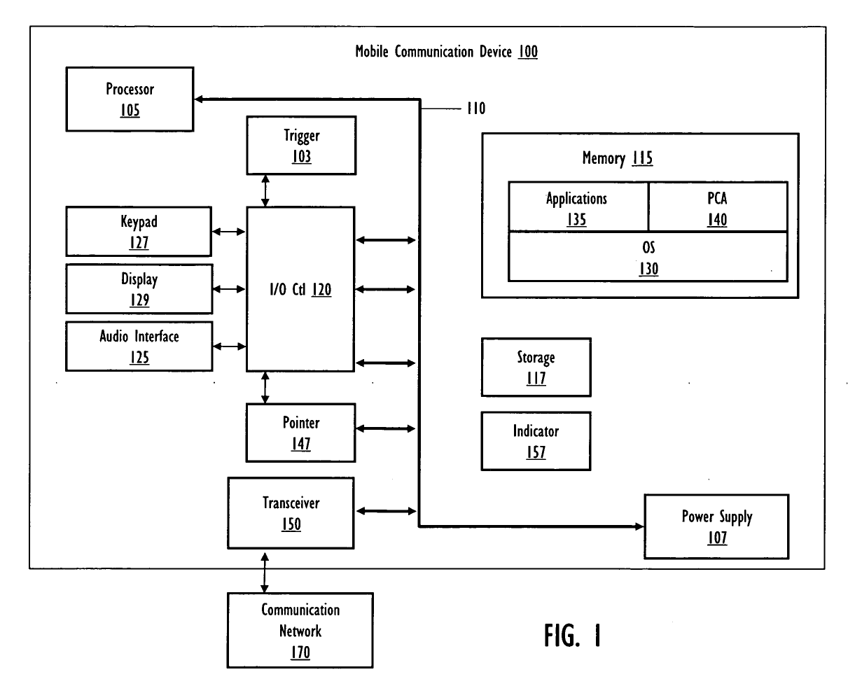

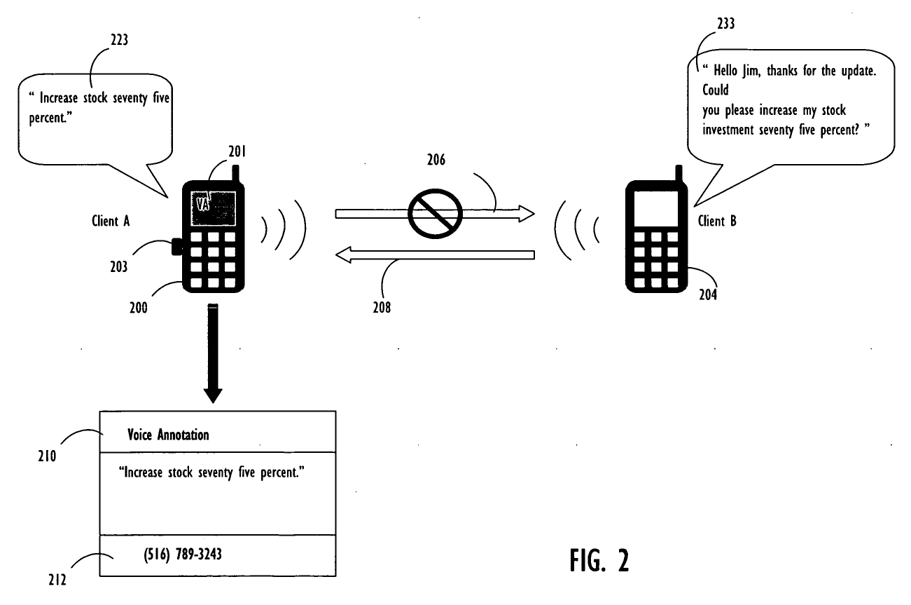

Within the descriptions of the figures, similar elements are provided similar names and reference numerals as those of the previous figure(s). Where a later figure utilizes the element in a different context or with different functionality, the element is provided a different leading numeral representative of the figure number (e.g, 1xx for FIG. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

With reference now to the figures, FIG. 1 depicts a block diagram representation of a mobile communication device (MCD). MCD 100 comprises at least one processor 105 connected to system memory 115 via system interconnect 110. Processor 105 may include a digital signal processor (DSP) for voice signal processing. Also connected to system interconnect 110 is I/O controller 120, which provides connectivity and control for (a) input devices, of which pointing device 147, keypad 127 as well as trigger 103 are illustrated, (b) output devices, of which display 129 is illustrated, and (c) audio interface 125, which provides a microphone input and speaker output. Pointing device 147 may be utilized to highlight an item, then select and/or engage the highlighted item. Keypad 127 may be a push button numeric dialing pad and/or a fully functional keyboard. Display 129 may be touch-sensitive, also acting as an input device. MCD 100 also comprises storage 117, within which data/instructions/code may be stored. MCD 100 is also illustrated with transceiver 150, with which MCD 100 may accesses external communication network 170, such as a wireless/cellular network.

MCD 100 also comprises indicator 157 and power supply 107. Indicator 157 may be one or more light emitting diodes utilized along with the output speakers of audio interface 125 as a notification mechanism. MCD 100 also utilizes power supply 107, which may be implemented as one or more batteries. Power supply 107 may also further include an external power source, such as an AC adapter or a powered docking cradle that supplements or recharges the batteries.

Notably, in addition to the above described hardware components of MCD 100, various features of the invention are completed via software (or firmware) code or logic stored within memory 115 or other storage (e.g., storage 117) and executed by processor 105. Thus, illustrated within memory 115 are a number of software/firmware components, including operating system (OS) 130 (e.g., Microsoft Windows®, a trademark of Microsoft Corp, or GNU®/Linux®, registered trademarks of the Free Software Foundation and The Linux Mark Institute), applications 135, and phone call annotation utility (PCA) 140. For simplicity, PCA utility 140 is illustrated and described as a stand alone or separate software/firmware component, which provides specific functions, as described below.

Processor 105 executes PCA utility 140 as well as OS 130, which supports the user interface features of PCA utility 140. In the illustrative embodiment, PCA utility 140 provides several graphical user interfaces (GUI) to enable user interaction with, or manipulation of, the functional features of the utility (140). Among the software code/instructions provided by PCA utility 140, and which are specific to the invention, are: (a) code for creating voice (or audio) and textual annotations; (b) code for associating voice/audio and textual annotations with call information; and (c) code for retrieving voice/audio and textual annotations. For simplicity of the description, the collective body of code that enables these various features is referred to herein as PCA utility 140. According to the illustrative embodiment, when processor 105 executes PCA utility 140, MCD 100 initiates a series of functional processes that enable the above functional features as well as additional features/functionality, which are described below within the description of FIGS. 2-10. Also, voice and audio are utilized interchangeably herein to describe audio communication.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The mobile communication device depicted in FIG. 1 may be, for example, a Blackberry™, Palm Treo™, iPhone™, and other devices capable of providing/executing outgoing and incoming calls. However, the device in which the application is utilized may not necessarily be a mobile device. The functionality described herein may be extended to other non-mobile communication devices, such as public switch telephone network (PSTN) phones (analog/digital) and voice over Internet protocol (VOIP) phones and the like.

With reference now to FIG. 2, wherein is depicted communication between two mobile communication devices. FIG. 2 comprises client A MCD 200 and client B MCD 204. Client A MCD 200 and client B MCD 204 engage in mutual conversation, as illustrated by outgoing sound 206 and incoming sound 208. Client A MCD 200, (similar to MCD 100 of FIG. 1), is configured with trigger 203. Trigger 203 may be an existing button on keypad 127 that is pre-programmed to function as a trigger during voice calls, and has the capabilities of activating PCA utility 140. While trigger 203 is engaged, client A MCD 200 is muted, as shown with outgoing sound 206. An indication such as voice annotation (VA) indication 201 is displayed, when trigger 103 is engaged, then the phone is muted, and recording begins. Statement A 223 is recorded and associated with call information 212 as illustrated with VA 210. Client B MCD 204 may continue to transmit statement 233 to client A MCD 200.

In the illustrative embodiment, an incoming call is received by client A MCD 200. During mutual conversation, client A MCD 200 engages trigger 203. Engaging trigger 203, mutes outgoing audible noise (206), such that client B MCD 204 does not receive any audible information while trigger 203 is engaged on client A MCD 200. A brief annotation is recorded on client A MCD 200 and associated with the phone number of client B MCD 204.

In one embodiment, trigger 203 is engaged to record a voice annotation, such as statement A 223. When trigger 203 is engaged, audible information is not transmitted to client B MCD 204. In one embodiment while statement A 223 from client A MCD 200 is recording, statement B 233, transmitted from client B MCD 204, is also recorded. Recording statement B 233 decreases the possibility that incoming information will be lost while recording statement A 233. Statement A 233 and statement B 233 are each automatically saved, stored, and linked to each other and to the phone number of client B MCD 204 within the call log of client A MCD 200. Releasing trigger 103 stops the recording of statement A 223 (voice annotation) and statement B 233.

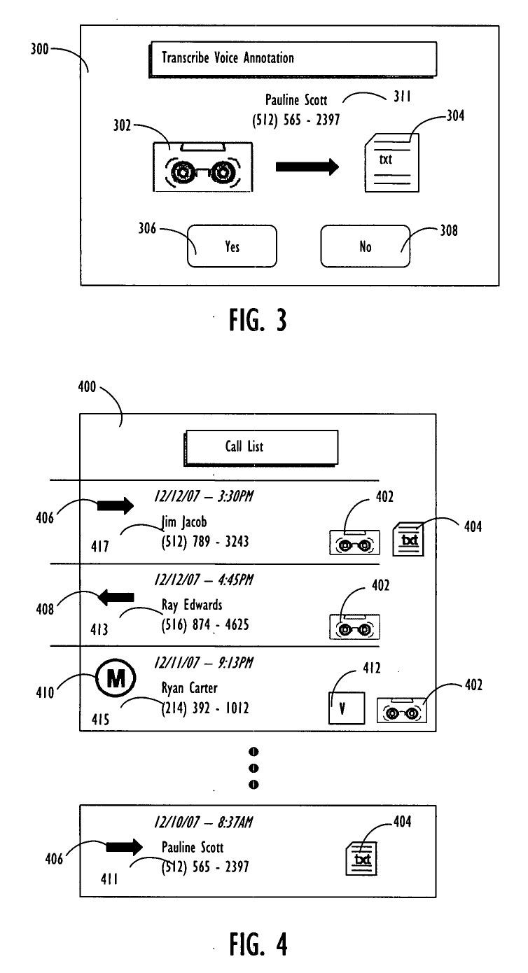

FIG. 3 illustrates a graphical user interface for transcribing a recorded voice annotation. Transcribe voice annotation GUI 300 displays call information 311, voice annotation icon 302 and text annotation icon 304. Selection yes 306 may be chosen to transcribe the verbal annotation, while selection no 308 may be chosen to not transcribe the verbal annotation.

In one embodiment, a voice annotation is recorded during a phone conversation. Following completion of the phone call transcribe voice annotation GUI 300 is automatically generated by PCA utility 140. The client is presented the opportunity to transcribe the annotation by choosing selection yes 306 on transcribe voice annotation GUI 300. If the client prefers not to transcribe at this moment, the client may choose selection no 308. Ending the call without further choosing selection yes 306 or selection no 308, simply closes transcribe voice annotation GUI 300. Transcribe voice annotation GUI 300 may be retrieved utilizing an option within the phone tools menu, options menu, or via an icon created on the phone. Converting the voice annotation to a textual annotation allows the message to be conveniently accessed and edited prior to incoming and outgoing calls. Once a voice annotation is transcribed the user also maintains the convenience of forwarding the information as a text message or e-mail.

Call list GUI 400, illustrated in FIG. 4 displays a call log of one or more calls received, dispatched, or missed by the client. Incoming calls, outgoing calls, and missed calls are illustrated by incoming call icon 406, along with outgoing call icon 408, and missed call icon 410. Icons such as voice annotation icon 402, text annotation icon 404, and voicemail icon 412 may be selected to retrieve the voice annotation, text annotation, or voicemail associated with the displayed call. Information associated with the call is displayed as call A entry 417, call entry B 413, call entry C 415, and call entry D 411. The call entry may comprise the name (when available), phone number (when available), date and time stamp of the call, as well as other information. The name and phone number of the call entry may be retrieved by searching an address book stored in storage 117 (FIG. 1) or memory 115 (FIG. 1), or retrieved from the caller identification (caller ID) associated with the incoming call.

In one embodiment, call entry A 417 is displayed as an incoming call received within call list GUI 400. A voice annotation was recorded, and a text annotation was transcribed from the recorded voice annotation, as indicated by voice annotation icon 402 and text annotation icon 404 for call entry A 417. Voice annotation icon 402 displayed with call entry B 413 illustrates no text annotation has been transcribed or the text annotation has been deleted. Text annotation icon 404, associated with call entry D 411, illustrates that the originally transcribed voice annotation has been deleted. Options to delete voice and or text annotations will be discussed hereafter.

In another embodiment, call C 415 displays missed call icon 410, voicemail icon 412, and voice annotation icon 402. While listening to the voicemail of call C 415, the client engages trigger 203 (FIG. 2) and records a voice annotation regarding the voicemail. During recording of the voice annotation, the phone number associated with the voicemail is linked to the voice annotation.

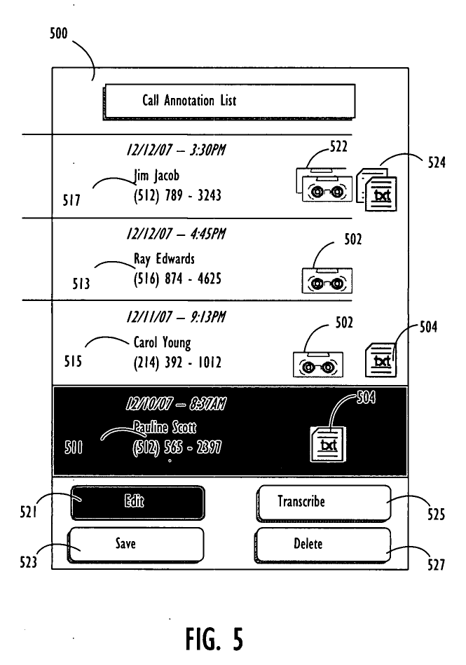

FIG. 5 illustrates call annotation list GUI 500. From call annotation list GUI 500 a client may transcribe 525, edit 521, save 523, and/or delete 527 voice or text annotations. Voice annotation icon 502 and/or text annotation icon 504 may be associated with call information, as well as multiple text annotation icons 524 and multiple voice annotation icons 522. Multiple call annotation icons illustrate two or more annotations are stored for the associated call. A subscript above or beside the icon may also be utilized to identify how many annotations are stored for the associated call. Call information is displayed for call entry A 517, call entry B 513, call entry C 515, and call entry D 511. Selecting a call entry to edit, save, transcribe and/or delete is indicated with by highlighting (illustrated by shading call entry region). Selecting a call entry may be accomplished utilizing pointing device 147 of FIG. 1

In one embodiment, call annotation list GUI 500 may be accessed from an options menu, tool menu, shortcut icon, and/or a call logs menu. Selecting call entry D 511 for editing is indicated by highlighting (shading) the call entry. Edit 521 is engaged (indicated by shading of edit 521). Edit 521 allows text annotation 504 to be corrected or revised, following transcription of a voice annotation. Edit 521 may also allow a voice annotation to be revised or corrected. Following any revisions, the text or voice annotation may be stored, utilizing save 523.

In another embodiment, transcribe 523 is utilized to transcribe the voice annotations. Call annotation list GUI 500 illustrates multiple voice annotations 522 and multiple text annotations 524 associated with call entry A 517. Each voice annotation created, associated with call entry A 517, is transcribed as illustrated by multiple text annotations 524. A text annotation may exist without a voice annotation as shown in association with call entry 511, wherein the voice annotation is deleted utilizing delete 527. Call entries may also be listed separately along with the call annotations, according to the time stamp of the call entry.

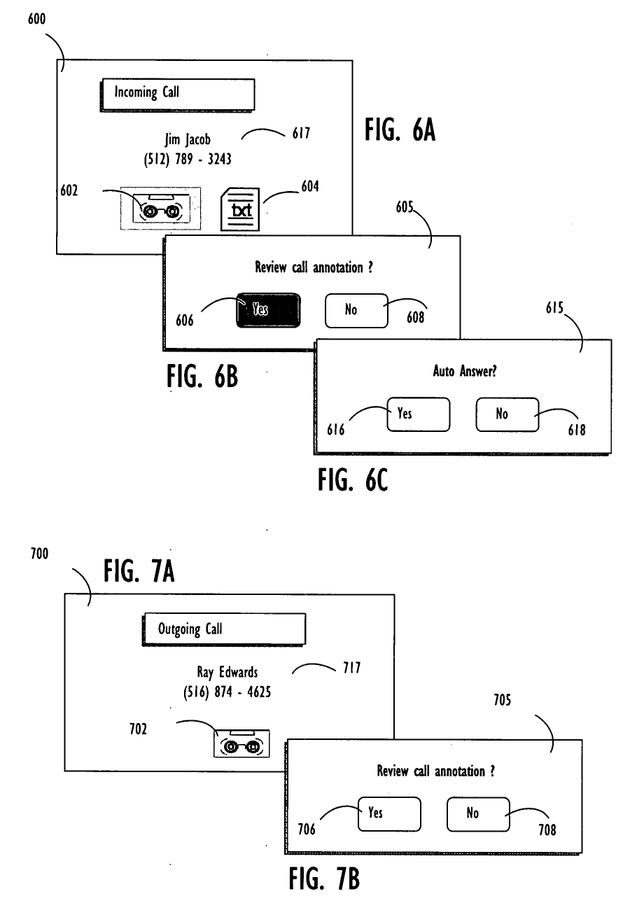

Prior to accepting an incoming call, a GUI such as incoming GUI 600 in FIG. 6A may be displayed comprising call information 617, voice annotation icon 602, and text annotation icon 604. Selection of voice annotation icon 602 is indicated by highlighting (shading background of icon). When incoming GUI 600 is displayed, review call annotation GUI 605 of FIG. 6B is also displayed giving the client an option to review the call annotation by choosing select yes 606, or not to review the call annotation by choosing select no 608. Choosing select yes 606 displays auto answer GUI 615 of FIG. 6C, wherein the client may choose select yes auto answer 616, or select no auto answer 618.

In one embodiment, when a call annotation is associated with the call information of an incoming call, incoming GUI 600 is automatically displayed. Voice icon 602 is selected (indicated by highlighting) to audibly review the annotation. Then, the client engages select yes 606 to play the voice annotation prior to answering the call. After engaging select yes 606, auto answer GUI 615 displays the option to have an automated voice message answer the call while the client is reviewing the annotation. Engaging select yes auto answer 616 causes the call to be dynamically answered with the following message, “Please hold, while you are connected”, or any message informing the caller that the call will be answered. Engaging select no auto answer 618 will permit the call to go to voicemail when available, if the call is not answered before the review is complete.

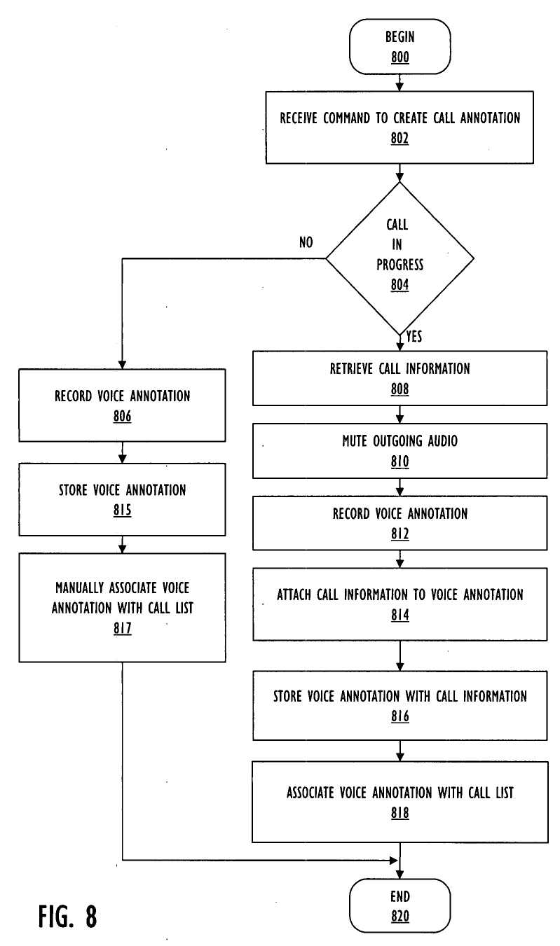

Outgoing calls associated with a voice annotation may display outgoing call GUI 700 of FIG. 7A. Within outgoing call GUI 700, voice annotation 702 is displayed with associated call information 717. FIG. 7B displays review call annotation GUI 705. Choosing select yes 706 will play the voice annotation, choosing select no 708 allows the outgoing call to be dialed.

In one embodiment, prior to dialing a phone number associated with a voice annotation, the client may decide to review the voice annotation. Choosing select yes 706 connects the client to the voice annotation. After listening to the voice annotation the client may commence dialing. When one or more annotations are displayed in outgoing call GUI 700, such as voice annotation icon and text annotation icon, the client may select which annotation to review, utilizing pointing device 147 of FIG. 1.

FIGS. 8-10 are flow charts illustrating various methods by which the above processes of the illustrative embodiments are completed. Although the methods illustrated in FIGS. 8-10 may be described with reference to components shown in FIGS. 1-7, it should be understood that this is merely for convenience and alternative components and/or configurations thereof can be employed when implementing the various methods. Key portions of the methods may be completed by PCA utility 140 executing within MCD 100 (FIG. 1) and controlling specific operations on MCD 100, and the methods are thus described from the perspective of both PCA utility 140 and MCD 100.

FIG. 8 is a logic flow chart illustrating the method of implementing the voice annotation application. The process of FIG. 8 begins at initiator block 800 and proceeds to block 802, at which a command is received to create a call annotation. A decision is made at block 804. If a call is in progress the utility proceeds to block 808 where the call information is retrieved. If there is no call in progress, the utility proceeds to block 806 where the voice annotation is recorded then stored at block 815. When the voice annotation is not associated with a call, the client may manually associate the annotation with information from the call list or address book at block 817. Then the process ends at block 820.

After retrieving call information at block 808, all outgoing audio is muted at block 810 so that the client on the receiving end does not hear the audible voice annotation. At block 812 the voice annotation is recorded. Call information associated with the voice annotation is automatically linked attached to the annotation at block 814. The voice annotation is then stored at block 816, and associated with a call list at block 818. The call list may be, for example, call list 400 of FIG. 4 or call annotation list GUI 500 of FIG. 5. The process ends at block 820.

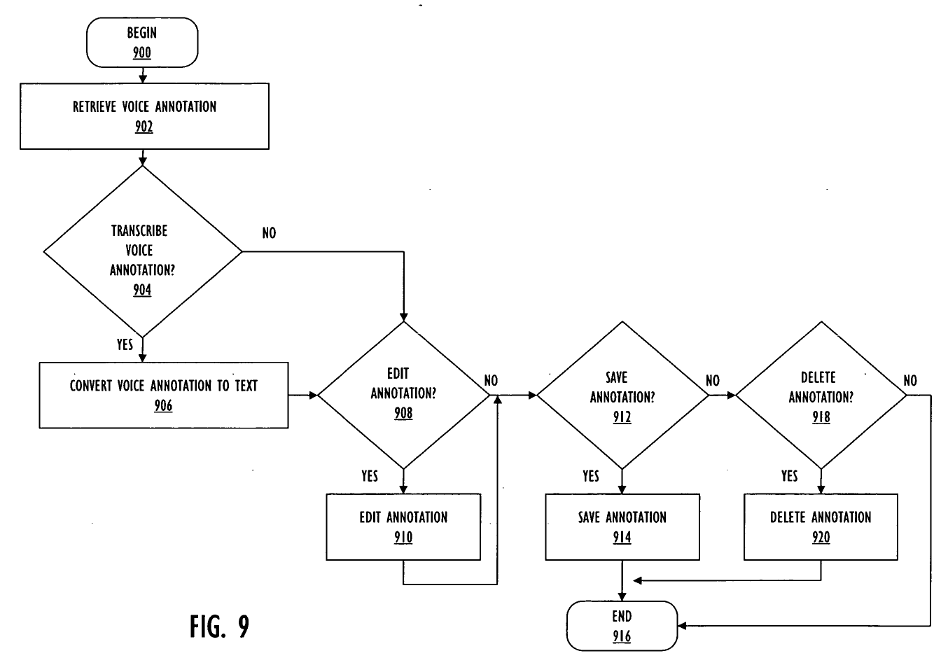

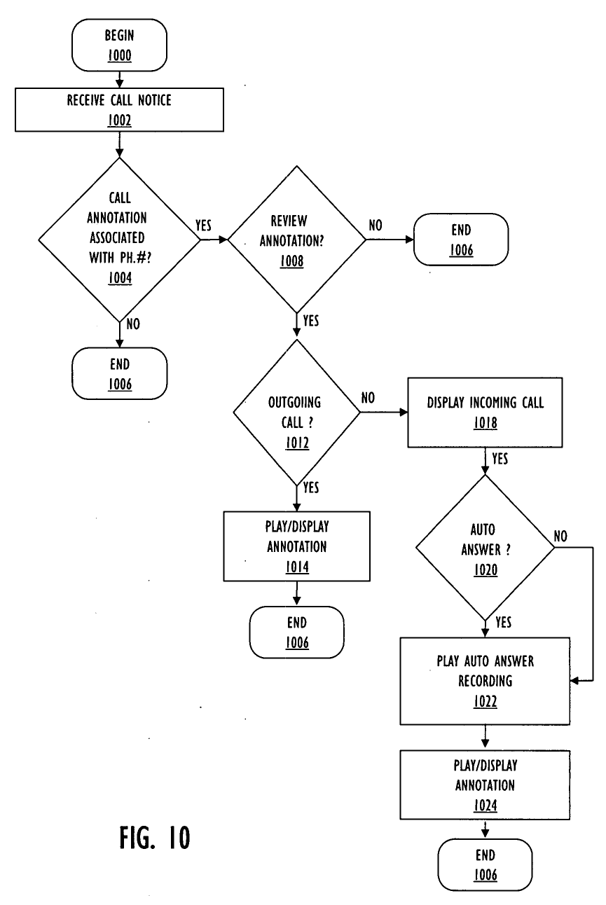

The flow chart of FIG. 9 illustrates the process for transcribing, editing, saving, and/or deleting call annotations. The flow chart of FIG. 9 begins at block 900. A voice annotation is retrieved at block 902. At block 904 a decision is made whether to transcribe the voice annotation or not transcribe the voice annotation. If a selection is received to transcribe the voice annotation, the process continues to block 906 where the voice annotation is converted to text, then proceeds to decision block 908. If a selection is made not to transcribe the voice annotation, the process continues directly to decision block 908. At decision block 908, a choice is made whether to edit the annotation (voice and/or text). If a selection to edit the annotation is received the process proceeds to block 910 where the annotation is edited, then continues to decision block 912. If a selection is made not to edit the annotation, the process proceeds to decision block 912.

At decision block 912, a choice whether to save the annotation is made. Although voice and text annotations are automatically saved following recording and transcription, any revisions must be save via manual selection of save. If the annotation is selected to be saved, the process continues to block 914, where the annotation is saved. The process ends at block 916. If the annotation is not required to be saved, the process continues to decision block 918 where the annotation may be deleted. If the annotation is not selected to be deleted, the process ends at block 916. If the annotation is selected to be deleted, the process continues to block 920, where the annotation is deleted. The process ends at block 916.

FIG. 10 is a logic flow chart illustrating the process of implementing the annotation application during incoming and outgoing calls. The process of FIG. 10 begins at block 1000. At block 1002 a notice to process a call (incoming or outgoing) is received. A decision is made at block 1004 whether a call annotation is associated with the phone number. If there is no call annotation associated with the phone number the process ends. If there is a call annotation associated with the phone number, the process continues to block 1008. At block 1008 a decision is made whether to review the annotation (voice or text). If a selection is made not to review the annotation, the process ends at block 1006. If a decision is made to review the annotation, a next decision is made at block 1012, whether the call is an outgoing call. If the call is an outgoing call, the process continues to display or play the call annotation at block 1014. The process ends at block 1006. If the call is not outgoing, then the call is an incoming call and the process continues to block 1018.

At block 1018, the incoming call information is displayed. A decision is made at block 1020 whether to answer the call with the automated answer message, while the annotation is reviewed. If a selection is made to not answer the incoming call with the automated message the process continues to block 1024. If a selection is made to answer the call with the automated message, a service retrieves the automated message and plays the automated answer, (e.g. “Please hold, while you are connected”). The process continues to block 1024 where the call annotation is displayed or played. The process ends at block 1006.

In the flow charts above, one or more of the methods are embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method comprising:
creating an annotation to a communication with a communication device;
associating the annotation to identifying information of the communication; and
automatically enabling access to the annotation during subsequent use of the identifying information.

2. The method of claim 1, further comprising:
receiving instructions to create the annotation;
storing the annotation with the identifying information; and
when a subsequent request is received to access the identifying information, dynamically retrieving the annotation and enabling access to the annotation.

3. The method of claim 1, wherein creating the annotation comprises:
activating a recording function within the communication device;
receiving an input of the annotation; and
recording the input of the annotation.

4. The method of claim 3, wherein the communication is a voice communication and the annotation is an audio annotation, the method further comprising:
automatically disabling outgoing audio on the communication device while recording the audio annotation during the voice communication;
recording an incoming voice communication while recording the audio annotation; and
enabling retrieval of both the audio annotation and the incoming voice communication via the identifying information.

5. The method of claim 3, further comprising:
receiving a selection to transcribe an audio annotation into a text annotation;
dynamically transcribing the audio annotation; and
storing a transcribed text annotation with the identifying information.

6. The method of claim 5, wherein transcribing further comprises:
displaying an interface for enabling initiation of the transcribing;
providing an output within the interface indicating that the text annotation is associated with the identifying information along with the audio annotation.

7. The method of claim 1, wherein said associating comprises:
selecting one or more of a contact information, a caller identifier (ID), and a call log as the identifying information with which to store the annotation;
linking the annotation to the selected one or more of the contact information, the caller ID, and the call log; and
storing the annotation with the selected one or more of the contact information, the caller ID, and the call log that identifies the communication with which the annotation refers.

8. The method of claim 1 further comprising:
generating an interface to display a list of communications with associated annotations; and
enabling completion of one or more functions via the interface from among, editing, saving, transcribing, and deleting one or more of the annotations associated with the communications.

9. A communication device comprising:
a receiver at which communication is received by the communication device;
a processor;
a memory component; and
a utility for executing on the processor and which includes program code that when executed provides the functions of:
creating an annotation to a communication with a communication device;
associating the annotation to identifying information of the communication; and
automatically enabling access to the annotation during subsequent use of the identifying information.

10. The device of claim 9, further comprising:
at least one input mechanism; and
wherein said utility further comprising program code for completing the functions of:
receiving, via one of the at least one input mechanism, instructions to create the annotation;
storing the annotation with the identifying information; and
when a subsequent request is received to access the identifying information, dynamically retrieving the annotation and enabling access to the annotation.

11. The device of claim 9, wherein the code for creating the annotation comprises code for:
activating a recording function within the communication device;
receiving an input of the annotation; and
recording the input of the annotation.

12. The device of claim 11, wherein the communication is a voice communication and the annotation is an audio annotation, the utility further comprising program code for:
automatically disabling outgoing audio on the communication device while recording the audio annotation during the voice communication;
recording an incoming voice communication while recording the audio annotation; and
enabling retrieval of both the audio annotation and the incoming voice communication via the identifying information.

13. The device of claim 11, said utility further comprising program code for completing the functions of:
displaying an interface for enabling initiation of transcribing of audio annotation;
receiving a selection to transcribe an audio annotation into a text annotation;
dynamically transcribing the audio annotation;
storing a transcribed text annotation with the identifying information;
providing an output within the interface indicating that the text annotation is associated with the identifying information along with the audio annotation.

14. The device of claim 9, wherein said code for associating comprises code for:
selecting one or more of a contact information, a caller identifier (ID), and a call log as the identifying information with which to store the annotation;
linking the annotation to the selected one or more of the contact information, the caller ID, and the call log; and
storing the annotation with the selected one or more of the contact information, the caller ID, and the call log that identifies the communication with which the annotation refers.

15. The device of claim 9, said utility further comprising code for completing the functions of:
generating an interface to display a list of communications with associated annotations; and
enabling completion of one or more functions via the interface from among, editing, saving, transcribing, and deleting one or more of the annotations associated with the communications;
creating an annotation to a first communication with a communication device;
associating the annotation to identifying information of the first communication; and
automatically enabling access to the annotation during subsequent use of the identifying information.

16. A computer program product comprising:
a computer readable medium; and
program code on the computer readable medium that when executed by a processor provides the functions of:
creating an annotation to a communication with a communication device;
associating the annotation to identifying information of the communication; and
automatically enabling access to the annotation during subsequent use of the identifying information.

17. The computer program product of claim 16, said program code further comprising code for:
receiving instructions to create the annotation;
storing the annotation with the identifying information; and
when a subsequent request is received to access the identifying information, dynamically retrieving the annotation and enabling access to the annotation.

18. The computer program product of claim 16, wherein the program code for creating the annotation comprises code for:
activating a recording function within the communication device;
receiving an input of the annotation;
recording the input of the annotation;
selecting one or more of a contact information, a caller identifier (ID), and a call log as the identifying information with which to store the annotation;
linking the annotation to the selected one or more of the contact information, the caller ID, and the call log; and
storing the annotation with the selected one or more of the contact information, the caller ID, and the call log that identifies the communication with which the annotation refers.

19. The computer program product of claim 18, wherein the communication is a voice communication and the annotation is an audio annotation, the program code further comprising code for:
automatically disabling outgoing audio on the communication device while recording the audio annotation during the voice communication;
recording an incoming voice communication while recording the audio annotation; and
enabling retrieval of both the audio annotation and the incoming voice communication via the identifying information.

20. The method of claim 18, further comprising:
generating an interface to display a list of communications with associated annotations;
displaying selectable options within the interface for enabling initiation of transcribing;
enabling completion of one or more functions via the interface from among, editing, saving, transcribing, and deleting one or more of the annotations associated with the communications;
receiving a selection to transcribe an audio annotation into a text annotation;
dynamically transcribing the audio annotation;
storing a transcribed text annotation with the identifying information; and
providing an output within the interface indicating that the text annotation is associated with the identifying information along with the audio annotation.
